(19) United States
(12) Patent Application Publication
(10) Pub. No.: US 2015/0100438 A1
(43) Pub. Date: Apr. 9, 2015

(54) SELECTING AMONG ADVERTISEMENTS COMPETING FOR A SLOT ASSOCIATED WITH ELECTRONIC CONTENT DELIVERED OVER A NETWORK BASED UPON PREDICTED LATENCY

(71) Applicant: Yahoo! Inc., Sunnyvale, CA (US)

(72) Inventors: Jon Malkin, Sunnyvale, CA (US); Mihajlo Grbovic, Mountain View, CA (US); Prabhakar Krishnamurthy, Pleasanton, CA (US); Karthikeyan Mariappan, La Quinta, CA (US); Hirakendu Das, Sunnyvale, CA (US)

(21) Appl. No.: 14/320,280

(22) Filed: Jun. 30, 2014

Related U.S. Application Data
(60) Provisional application No. 61/887,311, filed on Oct. 4, 2013.

(51) Int. Cl. G06Q 30/02; H04L 12/24

(52) U.S. Cl. CPC G06Q 30/0277; H04L 41/147
USPC 705/14.73

(57) ABSTRACT

Methods and apparatuses for delivering advertisements with electronic content provided over a network and, more specifically, to techniques for selecting among advertisements that are competing for a slot associated with electronic content that is to be delivered over a network, are presented herein. Selecting among advertisements that are competing for a slot is based, at least in part, on an estimated latency for each advertisement. The estimated latency of an advertisement is a prediction of what latency will be experienced if the advertisement is served. The estimated latency may be used as one of the parameters for determining which competing advertisement to place in a slot, where advertisements that are associated with low estimated latencies are favored. For example, if all other parameters are equal, a selection mechanism selects advertisement X over advertisement Y, if the estimated latency for advertisement X is less than the estimated latency of advertisement Y.

### CROSS-REFERENCE TO RELATED APPLICATIONS; BENEFIT CLAIM

This application claims the benefit under 35 U.S.C. §119(e) of provisional application 61/887,311, filed Oct. 4, 2013, the entire contents of which is hereby incorporated by reference for all purposes as if fully set forth herein.

### FIELD OF THE INVENTION

The present invention relates to delivering advertisements with electronic content provided over a network and, more specifically, to techniques for selecting among advertisements that are competing for a slot associated with electronic content that is to be delivered over a network.

### BACKGROUND

Electronic content is delivered to network users in many forms, such as email, web pages, audio streams, video streams and Java applets. Many companies (hereinafter “advertisers”) advertise their wares and services by paying popular content providers (hereinafter “providers”) to include the advertisers' advertisements or “ads” in the providers' content as that content is delivered to users.

Just as the form of the content may vary, so too may the form of the advertisement. For example, when the content is a web page the advertisement may be a banner ad. When the content is an email message, the advertisement may be text in a tag line. When the content is a stream of music or video, the advertisement may be a sound bite or video clip. The techniques described herein are not limited to any particular form of network-delivered content or advertisements.

Each time a content provider provides to a user content that includes the particular advertisement, an “ad-view” of the particular advertisement is said to have occurred. An ad-view is merely one form of “service unit” that an advertiser may purchase from a provider. Various other forms of service units are possible, including but not limited to: actual click-throughs on advertisements, actual viewing time of advertisements, actual orders resulting from advertisements, etc. The techniques described herein are not limited to any particular form of service unit.

As computers and network speeds have increased, users now expect web pages to load seemingly instantaneously. Along with wanting content to arrive quickly, websites want to ensure ads are also delivered promptly since sites cannot charge advertisers for ads that never show. Improving ad load times will ultimately improve both the user experience and the revenue for sites.

The online advertising world includes:
advertisers: those that wish to advertise a product, service or event;
providers or publishers: those that run the websites and want to supplement their income; and
ad exchanges: those that connect advertisers and providers to create a marketplace.

Late ads are problematic—if a page is delivered to a user but the ad fails to load in time, a publisher cannot charge the advertiser for that impression. The publisher will have lost that chance to make money. And, if the ad shows late, then the sudden appearance of an ad may provide a degraded user experience.

Users prefer faster loading pages. For users who are likely to engage with an advertisement, having an ad display sooner means the user has a chance to see the ad before becoming immersed in the page content. Even for a user who will not engage with an ad, having the completed page finish rendering quickly will avoid a potentially distracting page change as a white space placeholder is suddenly filled after starting to consume the page's content.

Financially, the impact of slow ads is clear: If an ad takes too long to load, the user may navigate away from the page before seeing the advertisement. This results in a missed opportunity for the advertiser and lost revenue for the publisher.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a flowchart for selecting an ad from a pool of ads to insert into a slot associated with electronic content that has been requested by a user, in an example embodiment.

FIG. 2 illustrates a flowchart for selecting an ad from a pool of ads to insert into a slot associated with electronic content that has been requested by a user, in an example embodiment.

FIG. 3 illustrates an alternative flowchart for selecting an ad from a pool of ads to insert into a slot associated with electronic content that has been requested by a user, in an example embodiment.

FIG. 4 illustrates a system upon which an embodiment of the invention may be implemented, in an example embodiment.

FIG. 5 is a block diagram that illustrates a computer system upon which an embodiment of the invention may be implemented.

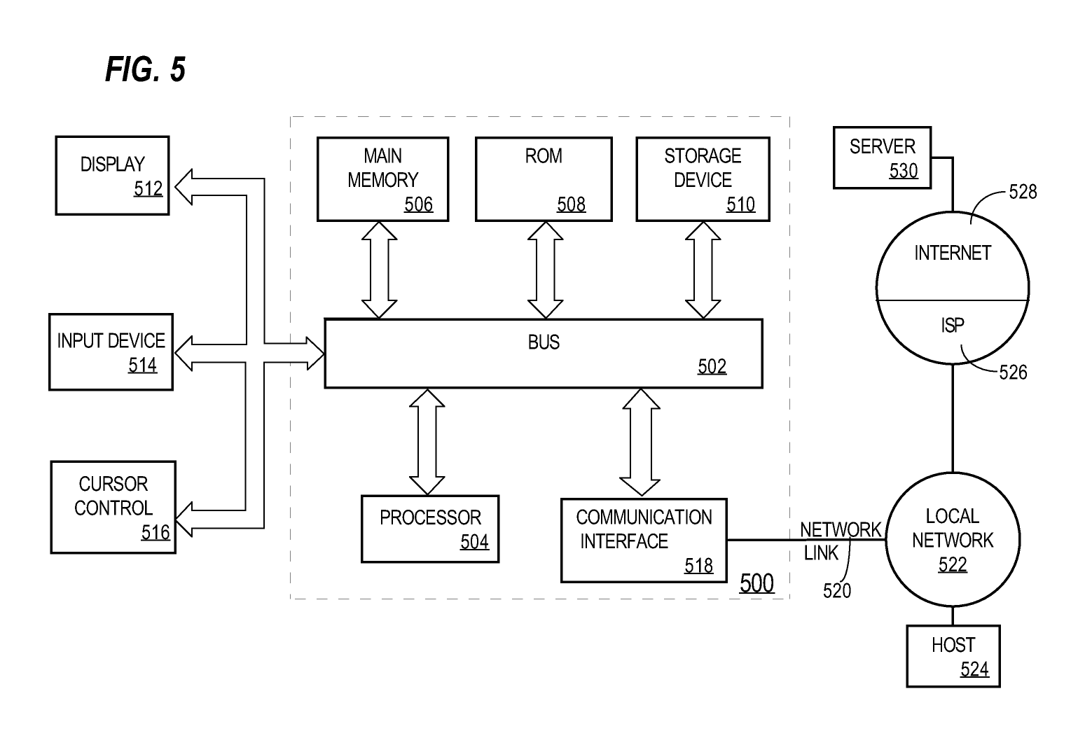

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Described hereafter are methods and systems for predicting which ads are likely to have high latency at serve time. Specifically, methods and systems for identifying the largest factors contributing to slow ad rendering times are discussed herein. Furthermore, methods and systems for predicting which ads are likely to be late based on the factors are discussed herein.

The predictions may be computed entirely at serve time, entirely pre-computed prior to serve time, or computed at serve time based on partial pre-computations made prior to serve time. The estimated latency is used as one of the parameters for determining which competing ad to place in a slot, where ads that are associated with low estimated latencies are favored.

Once ads that are predicted to have unacceptably-long latency times are identified, the system can either ignore those ads, even if they win the auction, or apply some sort of penalty to those ads. For example, a Pigovian tax can be applied to a bid for an ad that is likely to be shown late. Also for example, auctions may be based on the expected revenue after accounting for the probability of being late.

### ESTIMATING AD LATENCY

According to one embodiment, estimating the latency that will be experienced by electronically-communicated advertisements involves (1) gathering historical information about previous ad presentations, the factors (static and dynamic) associated with those ad presentations, and the latencies experienced during those ad presentations; (2) using a machine-learning tool to generate a model based on that historical information; and (3) applying the model to predict ad latency for ads that are competing for a slot in an electronic content to be delivered to a particular user.

### Gathering Historical Information about Latency

The historical information used to generate a model may include both “static factors” and “dynamic factors” that were involved in previous ad presentations. Additionally or alternatively, a model may include “cached factors”.

“Static factors” are factors that are known before the time at which an ad must be selected to be served to a user (“serve time”). Static factors may be related to, or inherent in, an ad or the producer from which the ad must be retrieved. Static factors may include factors related to infrastructure. Static factors may include, but are in no way limited to, an advertiser's account, properties (e.g., web sites) the ad will be served on, space(s) on a property the ad will be served on, position(s) of the ad or slot in a web page, data center(s) hosting the publisher's content, ad network(s) the publisher is using, ad storage location(s), ad size in kilobytes or some other unit of measure, ad dimensions (in pixels, points, or any other unit of measure), an ad network, server type, and the server type of the publisher.

“Dynamic factors” are factors that are not known or not collected until serve time. Dynamic factors are typically factors related to users and/or the current state of the computing environment. Dynamic factors may include, but are in no way limited to, the user's device, operating system, browser, connection speed, country, state, city, internet service provider (“ISP”), and distance to the data server and/or data center sending the page content or the server content. Whether or not a client is a “robot” may also be a dynamic factor. A “robot” may be a computer and/or software executed by a computer that automates sending and/or receiving data, such as a web scraper or web crawler.

“Cached factors” are dynamic factors, but are static for at least a short period of time and/or for a particular user, or set of users. For example, cached factors for a particular user may include, the browser most frequently used, operating system or device most frequently used, most common location, birthdate, and/or user preferences or settings. Cached factors may be cached in a data base, cookie, and/or other storage.

Factors may also include the content of an ad (for example, text, video, interactive, flash, etc.), whether an ad is animated or static, whether an ad contains multiple components or segments, whether an ad size changes. Some factors may be linear and/or non-linear combinations of other factors. For example, a transform or function may be applied to one or more factors to derive a new factor.

Thus, the historical data may include, for each instance in which an ad was presented to a user in the last week, a record indicating the latency experienced, a list of values associated with the static factors, and a list of values associated with the dynamic factors. As shall be described hereafter, this historic information may be fed to a machine learning tool as “training data” to cause the machine learning tool to generate a model for predicting latency based on values for dynamic factors associated the user to whom an ad is to be served and/or static factors associated each candidate ad.

In an embodiment, historical data comprises a collection of records. Each record identifies factors involved in presenting an ad and the resulting latency. A record may be denoted as “(V, R)”, where V is a factor vector and R is the determined latency. R may be binary or describe a length of time. For example, if R is “1”, then the time between an ad request and the ad rendering is more than a threshold and is considered late. If R is “0”, then the ad is considered not late. Other values may be used to represent the binary value as late or not late. Alternatively, if R represents a length of time and is “200”, then the latency was determined to be 200 milliseconds.

A factor vector may be denoted herein as “<X, Y>”, where a first factor is associated with the first element, X, and X identifies a particular factor involved in presenting the ad; and where a second factor is associated with the second element, Y, and Y identifies a particular factor involved in presenting the ad. Each factor in the factor vector may use one-hot encoding to identify a particular factor. A factor vector may have many more than two elements. For purposes of illustrating a clear example of two records, assume the following:
(1) A first ad was selected for a first ad slot, the first ad is hosted at a first data center, the first ad was presented by a client computer using a first web browser, and the latency was determined to be over one second.
(2) A second ad was selected for a second ad slot, the second ad is hosted at the first data center, the second ad was presented by a client computer using a second web browser, and the latency was under a second.
(3) If the latency is a more than a second, then the ad is considered to be late.
(4) If the latency is equal to or less than one second, then the ad is considered to be not late.

Thus, the first record is denoted as (<1, 1>, 1). The first element in the factor vector is associated with data centers. The value of the first element, “1”, identifies a particular data center: the first data center. The second element in the factor vector is associated with browsers. The value of the second element, “1”, identifies a particular browser: the first browser. The second value in the first record, “1”, indicates that ad was late. In the current example, if the latency is a more than a second, then the ad is considered to be late. However, in other embodiment, a different threshold may be used, such as 0.5 seconds, three seconds, and/or any other amount of time.

The second record is denoted as (<1, 2>, 0). The first element in the factor vector is associated with data centers, like the first element in the factor vector in the first record. The value of the first element, “1”, identifies a particular data center: the first data center. The second element in the factor vector is associated with browsers, like the second element in the factor vector in the first record. The value of the second element, “2”, identifies a particular browser: the second browser. The second value in the second record, “0”, indicates that ad was not late.

### Generating a Model Based on the Historical Information

The system includes an analysis tool to discover the sources of latency in online advertising. The analysis tool may use logistic regression to compute the weight of each factor. Additionally or alternatively, models and estimated latencies may be computed using any one of the numerous types of machine learning tools currently available. For example, one or more neural networks, decision trees, naïve bayes classifiers, gene expressions, and/or any other machine learning or statistic-based method may be used to generate a model and/or compute the estimated latency of an ad.

Using logistic regression, a weight vector is generated. Each element in the weight vector corresponds with an element in a factor vector. For example, a first weight may correspond to a first browser, and a second weight may correspond to a second browser. In an embodiment, positive weight indicates a higher likelihood of latency, and a negative weight indicates a lower likelihood of latency. The magnitude of the weight may indicate how likely an ad will have a lower or higher latency. For example, a negative weight with a higher magnitude, such as “−70”, indicates a higher likelihood of having less latency than a negative weight with less magnitude, such as “−8”. In an embodiment, a higher weight may indicate a lower likelihood of latency and a lower weight may indicate a higher likelihood of latency. In an embodiment, the weights are greater than zero. In an embodiment, a greater magnitude indicates a higher likelihood of latency. In an embodiment, a greater magnitude indicates a lower likelihood of latency.

In an embodiment, feature or factor selection techniques, such as information gain, may be used to sort the factors as well, by assigning a score to each factor based on correlation to the label. Additionally or alternatively, a score may be transformed into a probability based on a sigmoid function. For example, factors that are associated with weights too close to zero, may be determined to be insubstantial and/or too noisy. Thus, weights that are within a particular range of a value, such as a zero, may be removed from a weight vector.

Depending on the nature of the model, the prediction produced by the model may be in the form of a binary YES/NO indicator that indicates whether an ad will incur an acceptably small latency (such as less than or equal to a threshold, e.g., one second, two seconds, or three seconds), an amount of time that indicates how long the latency is predicted to be, and/or a range of time that indicates a range of durations for the latency. As an example of the latter, the prediction may be that there is a 90% chance that serving a particular ad will result in latency between 10 ms and 20 ms.

### Updating the Model

A model may be computed and updated regularly. For example, the latency data and factors described herein may be collected hourly, daily, weekly, monthly, and/or yearly. The model may be recomputed based on the recently collected data. Recently collected data may be given more weight than previously collected data. In an embodiment, a new model may be computed each day using historical data from the most recent seven days.

### Ad Selection Based on Latency

Techniques are described herein for selecting among advertisements that are competing for a slot based, at least in part, on “estimated latency” for each advertisement. The estimated latency of an ad is a prediction of what latency will be experienced if the ad is served. According to an embodiment of the invention, the estimated latencies of ads are considered as a factor independent from the total revenue that may be earned from the corresponding advertisers. In one embodiment, the estimated latencies impose a tax or penalty to monetary values that the advertisers offer to pay the provider relative to the ads that are competing for a slot.

The estimated latency is used as one of the parameters for determining which competing ad to place in a slot, where ads that are associated with low estimated latencies are favored. For example, if all other parameters are equal, the selection mechanism selects ad X over ad Y, if the estimated latency for ad X is less than the estimated latency of ad Y.

Two examples of penalties, based on estimated latency, are a Pigovian tax, a tax designed to compensate for a negative externality, or manipulating ranking ads by the expected revenue (vs. today's approach of assuming the cost will be paid 100% of the time). Since a content provider cannot charge an advertiser more than the contracted amount, these penalties have the effect of decreasing the effective bid, forcing an advertiser to pay more to win the same auctions as he or she would have without the penalty.

Various benefits result from using the estimated latencies of ads as a factor to select which of the competing ads to include in a slot. For example, a provider is likely to generate more revenue from advertisers, because slots for which many advertisers are competing will be filled with ads more likely to be displayed.

The techniques for estimating latency, described herein, will help providers avoid attempting to show ads which will not ultimately be displayed. Using these techniques, a provider may experience increased revenue (or, depending on details of current ad impression tracking, avoiding a future loss of revenue) as a result of either fixing issues leading to late ads or selecting alternative ads that are more likely to arrive in time.

### Using Ad Latency as a Factor in Selecting Ads to Serve During Serve Time

As mentioned above, techniques are described herein for using an estimated latency as a factor in determining which ad to assign to a slot when there are multiple ads that are competing for the slot. According to one embodiment, the selection process takes into account a variety of other factors as well, such as the priority class to which the advertisements belong.

### Select Ads Based on Lowest Estimated Latency

The advertisements may be divided up, for example, so that ads associated with “guaranteed” contracts belong to a first priority class, and ads associated with “non-guaranteed” contracts belong to a second priority class. In one embodiment, the provider is obligated to serve the ads in the first priority class before serving the ads in the second priority class.

According to one embodiment, the selection process takes the aforementioned factors into account by selecting which ad to insert into a slot based on the following rules:
(1) filter out all advertisements that have delivery criteria that are not satisfied by the attributes of the slot;
(2) filter out all advertisements that are not in the highest remaining priority class; and
(3) select the remaining ad that is associated with the lowest estimated latency.

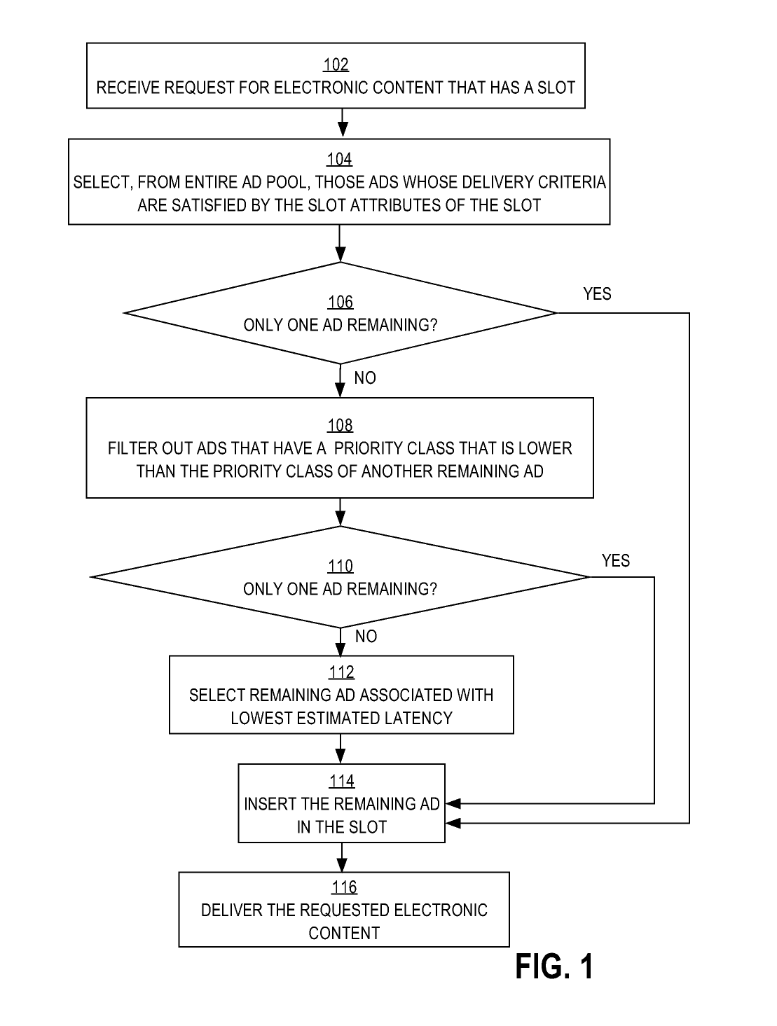

FIG. 1, it illustrates a flowchart for selecting an ad from a pool of ads to insert into a slot associated with electronic content that has been requested by a user, in an example embodiment. While FIG. 1 illustrates a particular embodiment for purposes of illustrating a clear example, other embodiments may omit, add to, reorder, and/or modify any of the elements shown. In one embodiment, ads in a pool of ads are associated with “lines” that advertisers submit to a provider. Each line includes information that includes, but is no way limited to, the potential revenue amount of a contract between an advertiser and the provider regarding one or more ads, the date of the contract, the delivery criteria of the ads, and the ads themselves, the hosting service providing each ad, and/or the bandwidth available to serve each ad.

At step 102, a request is received for content that has a slot. Such a request may be, for example, a request for a web page that a web server receives from a user over the Internet. At step 104, the ad selection mechanism determines which ads, among the ads in the entire ad pool, have delivery criteria that are satisfied by the slot attributes of the slot. This determination, which is made in response to receipt of the request, may involve a significant amount of computational resources given the number of active advertisement contracts the provider may have entered, the number of delivery criteria that can be associated with each advertisement, and the number of attributes that can be associated with a given slot.

If the delivery criteria of only one ad are satisfied by the slot attributes, then control passes from step 106 to step 114, where the only qualifying ad is inserted into the slot. Control then passes from step 114 to step 116, where the requested electronic content is delivered to the user that issued the request.

On the other hand, if the delivery requirements of more than one ad are satisfied by the slot attributes, then control passes to step 108. At step 108, ads that have a priority class that is lower than the priority class of another remaining ad are filtered out of the pool. For example, if the ad pool that remains after step 104 includes two first priority ads and three second priority ads, then during step 104 the three second priority ads would be filtered out of the remaining set of qualifying ads.

If, after filtering out the lower priority ads, only one ad remains, then control passes from step 110 to step 114, where the one remaining ad is inserted into the slot. Control then passes from step 114 to step 116, where the requested content is delivered to the user that issued the request.

On the other hand, if more than one ad remains after the lower priority ads have been filtered, then control passes to step 112. At step 112, the remaining ad associated with the lowest estimated latency is selected for insertion. Control then passes to step 114, where the selected ad is inserted into the slot, and from step 114 to step 116, where the requested content is delivered to the user that issued the request.

The steps as illustrated in FIG. 1 may be altered and still remain within the scope of the aforementioned selection mechanism. For example, an alternative embodiment of the selection mechanism may include additional steps, eliminate certain steps, or re-order the sequence of the steps.

According to one such embodiment, a provider reserves a portion of an inventory of slots for a group of “qualified” ads, which are any of the ads that have an estimated latency below a particular threshold. For example, at step 112, any remaining ads associated with an estimated latency equal to, or below, a particular threshold may be inserted. The ads that are qualified will then be associated with the first priority class, as mentioned above, and will be served before other ads. The new ads associated with qualified advertisers, which are advertisers associated with qualified ads, may be associated with the first priority class, as discuss herein, and may be served before other ads.

According to another such embodiment, a provider reserves a portion of an inventory of slots for a group of “qualified” advertisers. The provider selects from the qualified advertisers based, at least in part, on predicted traffic, types of electronic content, and the reputation, financial stability, and history of the advertisers. The advertisers that are selected as “qualified advertisers” qualify for “guaranteed” contracts. If the contracts are indeed entered into, the ads from these qualified advertisers will then be associated with the first priority class, as discussed herein, and will be served before other ads.

As to the non-reserved portion, the provider does not guarantee ad delivery but offers the available slots within the portion to anybody who may still be interested in the slots. In one embodiment, the provider may offer less than the maximum number of the available slots to increase demand and/or competition for a more limited supply. For example, although there are 1,000 available slots, the provider may indicate that 700 slots are available for bidding. As a result, interested advertisers may increase the prices of their bids to ensure that they obtain the slots. In addition, the provider may set an initial bidding price for the interested parties.

### Filter Ads Based on Estimated Latency

According to one embodiment, the selection process takes predicted ad latency into account by selecting which ad to insert into a slot based on the following rules:
(1) filter out all advertisements that have delivery criteria that are not satisfied by the attributes of the slot;
(2) filter out all advertisements that are not in the highest remaining priority class;
(3) filter out all advertisements with an estimated latency above a particular threshold; and
(4) select the remaining ad that is associated with the highest potential revenue amount.

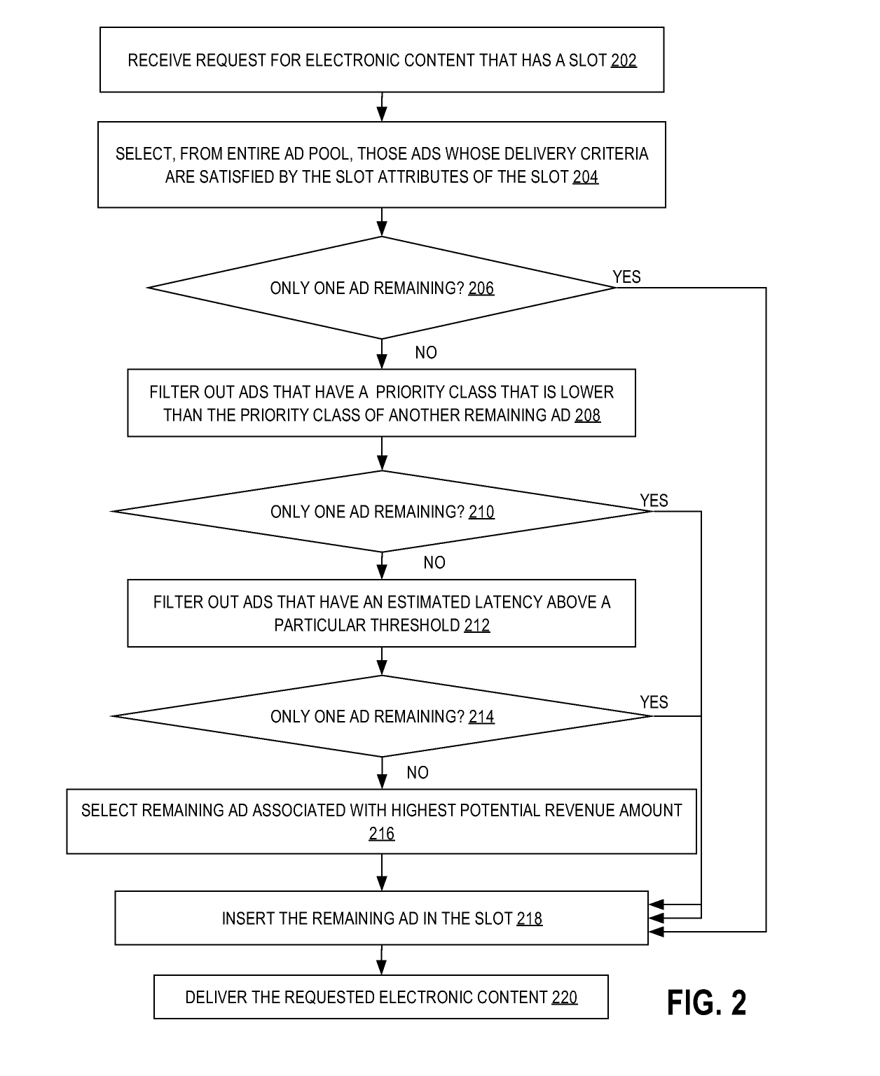

FIG. 2, it illustrates a flowchart for selecting an ad from a pool of ads to insert into a slot associated with electronic content that has been requested by a user, in an example embodiment. In one embodiment, the pool of ads is associated with lines that advertisers submit to a provider, as discussed herein.

At step 202, a request is received for content that has a slot. Such a request may be, for example, a request for a web page that a web server receives from a user over the Internet. At step 204, the ad selection mechanism determines which ads, among the ads in the entire ad pool, have delivery criteria that are satisfied by the slot attributes of the slot. This determination, which is made in response to receipt of the request, may involve a significant amount of computational resources given the number of active advertisement contracts the provider may have entered, the number of delivery criteria that can be associated with each advertisement, and the number of attributes that can be associated with a given slot.

If the delivery criteria of only one ad are satisfied by the slot attributes, then control passes from step 206 to step 218, where the only qualifying ad is inserted into the slot. Control then passes from step 218 to step 220, where the requested electronic content is delivered to the user that issued the request.

On the other hand, if the delivery requirements of more than one ad are satisfied by the slot attributes, then control passes to step 208. At step 208, ads that have a priority class that is lower than the priority class of another remaining ad are filtered out of the pool. For example, if the ad pool that remains after step 204 includes two first priority ads and three second priority ads, then during step 204 the three second priority ads would be filtered out of the remaining set of qualifying ads.

If, after filtering out the lower priority ads, only one ad remains, then control passes from step 210 to step 218, where the one remaining ad is inserted into the slot. Control then passes from step 218 to step 220, where the requested content is delivered to the user that issued the request.

On the other hand, if the delivery requirements of more than one ad are satisfied by the slot attributes, then control passes to step 212. At step 212, ads that have an estimated latency above a particular threshold are filtered out of the pool. For example, if the ad pool that remains after step 208 includes two ads with an estimated latency equal to, or below, a particular threshold and a third ad that has an estimated latency above a particular threshold, then during step 212 the third ad would be filtered out of the remaining set of qualifying ads. Additionally or alternatively, ads may be filtered out if the estimated latency is not below a particular threshold.

If, after filtering out the lower priority ads, only one ad remains, then control passes from step 214 to step 218, where the one remaining ad is inserted into the slot. Control then passes from step 218 to step 220, where the requested content is delivered to the user that issued the request.

On the other hand, if more than one ad remains after the ads with estimated latencies above a particular threshold have been filtered, then control passes to step 216. At step 216, the remaining ad associated with the highest revenue amount is selected for insertion. Control then passes to step 218, where the selected ad is inserted into the slot, and from step 218 to step 220, where the requested content is delivered to the user that issued the request.

The steps as illustrated in FIG. 2 may be altered and still remain within the scope of the aforementioned selection mechanism. For example, an alternative embodiment of the selection mechanism may include additional steps, eliminate certain steps, or re-order the sequence of the steps.

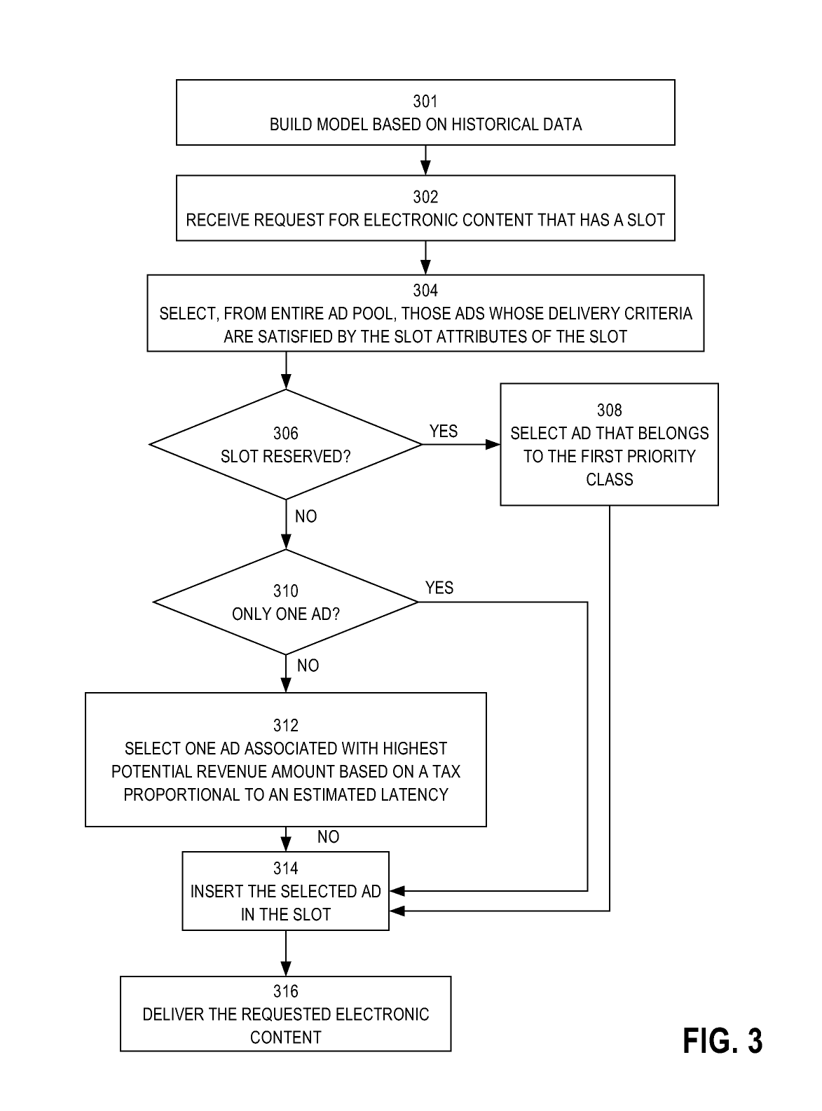

FIG. 3 illustrates an alternative flowchart for selecting an ad from a pool of ads to insert into a slot associated with electronic content that has been requested by a user. In step 301, a model is built based on historical data. For example, a vector of weights is computed as discussed herein. Those weights may be used to compute the estimated latency for each ad, at serve time as discussed in step 312, or before serve time as discussed herein.

At step 302, a request is received for content that has a slot. At step 304, the ad selection mechanism determines which ads, among the ads in the entire ad pool, have delivery criteria that are satisfied by the slot attributes of the slot. Then, the ad selection mechanism at step 306 determines the reservation status of the slot. If the slot has been reserved for the qualified advertisers, then control passes from step 306 to step 308, where an ad is selected if the ad belongs to the first priority class. This qualifying ad is inserted into the slot at step 314 and delivered along with the requested electronic content to the user that issued the request at step 316.

On the other hand, if the slot has not been reserved and only one ad has been selected at step 304, then control passes from step 310 to step 314, where the selected ad is inserted into the slot. Control then passes from step 314 to step 316, where the requested content is delivered to the user that issued the request.

If the slot has not been reserved but multiple ads have been selected at step 304, then control passes to step 312. At step 312, a potential revenue amount is computed for each selected ad. For example, an estimated latency is computed for a selected ad. A tax is computed based on the estimated latency. The potential revenue amount for the ad is computed based, at least in part, on a bid price and/or the tax computed for the ad. The ad associated with the highest revenue amount is selected for insertion. In an embodiment, the potential revenue amount for an ad is the ad's bid price minus the tax computed for each ad. A tax need not only reduce the potential amount. In an embodiment where the latency for an ad is estimated to be low, the tax may increase the potential revenue amount. Control then passes to step 314, where the selected ad is inserted into the slot, and from step 314 to step 316, where the requested content is delivered to the user that issued the request.

### Serve-Time Predictions

In an embodiment, a model (for example, a set of weights) is “pre-computed” (computed before receiving a request for an ad), and the estimated latency for each suitable ad is estimated at serve time based on the pre-computed model. For example, in response to a request for a web page that has a slot for an advertisement, the pool of available advertisements may first be filtered based on a variety of factors unrelated to latency (such as the characteristics of the user to whom the ad is to be served, the contractual obligations associated with the ads, etc.) Once the pool of available advertisements has been filtered down to relatively small set of candidate ads, the model may be used to predict the latency that would be incurred by each of the candidate ads. The prediction is generated by feeding values for the relevant factors (including both static and dynamic factors) for each ad into the model.

For purposes of illustrating a clear example of feeding values for each ad into a model which comprises a vector of weights, assume the following:
(1) there are two ads from which to select for an ad slot;
(2) the first ad is hosted at a first data center, which is associated with a first weight in the vector of weights: 3;
(3) the second ad is hosted at a second data center, which is associated with a second weight in the vector of weights: −1; and
(4) the request is sent by a client computer to a web server computer via a particular ISP, which is associated with a third weight in the vector of weights: 4.

In this example, a first result vector, which is associated with the first ad and the request, and which comprises the weights associated with the relevant factors for the first ad and the request, is <3, 4>. A second result vector, which is associated with the second ad and the request, and which comprises the weights associated with the relevant factors for the second ad and the request, is <−1, 4>. The sum total the elements in the first result vector is 7, and the sum total of the elements in the second result vector is 3. Thus, in this example, the first ad has a higher likelihood of displaying late than the second result, because the sum total of the first result vector is greater than the sum total of the second result vector.

### Pre-Computing Estimated Latency

In an alternative embodiment, estimated latency for one or more ads may be pre-computed. For example, static factors are used to pre-compute the estimated latencies entirely before serve time. For example, after the model is built, the weights may be applied to the static factors to generate estimated latencies. The estimated latencies may be stored in a database, hash table, or some other storage device or system.

Also for example, using the embodiment illustrated in FIG. 3, in step 312, instead of computing an estimated latency for each selected ad at serve time, the static factors associated with each selected ad are used to lookup the pre-computed estimated latency. Additionally or alternatively, the taxes applied to each selected ad in step 312 may also be pre-computed. Accordingly, the static factors associated with each selected ad are used to lookup the pre-computed tax. Additionally or alternatively, the potential revenue with the applied tax may also be pre-computed. Accordingly, the static factors associated with each selected ad are used to lookup the pre-computed potential revenue with applied tax.

Additionally or alternatively, cached factors are used to pre-compute the estimated latencies. For example, the dynamic factors for a user registered with a website may already be cached: browser, operating system, device, country, state, city, ISP, connection speed, etc. Accordingly, in step 301, after the model is built, the weights may be applied to the static factors and the cached factors to generate estimated latencies. In step 312, instead of computing an estimated latency for each selected ad, the static factors associated with each selected ad and cached factors associated with the user requesting the electronic content are used to lookup the pre-computed estimated latency. If the user requesting the electronic content is not registered, but the received dynamic factors are the same as the cached factors of another user, then instead of computing an estimated latency for each selected ad, the static factors associated with each selected ad and cached factors associated with the user requesting the electronic content are used to lookup the pre-computed estimated latency. Additionally or alternatively, if the user requesting the electronic content is not registered, then the estimated latency for each ad may be computed at serve time in step 312. Additionally or alternatively, the estimated latencies for one or more ads for a particular user may be stored in a database, cached in a cookie, or stored in some other system or storage device.

### Partially Estimating Latency before Serve time

A “hybrid estimated latency” may be computed based on both a pre-computed estimated latency and a latency computed at serve time (“serve-time estimated latency”). Furthermore, a tax may be computed based on both a pre-computed estimated latency and a serve-time estimated latency. For example, a tax may be computed based on a transform or function, such as a mean or median, of an estimated pre-computed latency using static and/or cached factors, and a serve-time estimated latency using dynamic factors.

In an embodiment, a hybrid estimated latency for an ad is binary: late or not late. For example, to determine whether a hybrid estimated latency is late or not late, if either the pre-computed estimated latency or the serve-time estimated latency is late, then the hybrid estimated latency is late. Otherwise, the hybrid estimated latency is not late. Alternatively, if either the pre-computed estimated latency or the serve-time estimated latency is not late, then the hybrid estimated latency is not late. Also for example, if a pre-computed estimated latency is different than the serve-time estimated latency, then the magnitude of the pre-computed estimated latency and the serve-time estimated latency may determine the hybrid estimated latency.

### Ad Selection Based on Latency Using a Decision Tree

Each of the factors discussed herein may be used to generate a decision tree. Each node in the decision tree may be based on a particular factor and/or may be associated with one or more ads. For example, a tree may have a first node that corresponds to whether or not the user is using a particular browser, if yes, control passes to node AA, and if no, control passes to node BB. Node AA may indicate which ads will have lower estimated latency than for the particular browser; node BB may indicate which ads will have lower estimated latency for other browsers. Additionally or alternatively, node AA may also be associated with other factors and control may traverse the decision tree based on the factors associated with each node according to the dynamic factors associated with the user requesting the electronic content. When a leaf node is reached, an ad associated with that leaf node may be selected. Additionally or alternatively, each node and/or leaf node may be associated with a range of estimated latencies or a particular estimated latency. Thus, the estimated latency may be determined by traversing the decision tree, based on static factors and/or dynamic factors associated with each ad and/or user.

### Additional Responses to Estimated Latency

Using the methods described herein, it may be determined that a particular ad has high estimated latency. In response, publishers, advertisers, and/or any other party may make changes to reduce latency. For example, in response to a determination that an advertiser's ad has a high estimated latency, an advertiser may provide a second ad that may be served to users when the latency for the first ad is estimated to be too high. Also for example, in response to a determination that ads on a publisher's site have high estimated latencies, the publisher may reduce the number of assets (pictures, scripts, etc.) that are being loaded in order to render ads more quickly. Additionally or alternatively, a publisher may request one or more assets after receiving and/or loading an ad in a slot. Publishers and/or advertisers may also switch hosting services or data stores in order to improve estimated latency.

### Network Topology

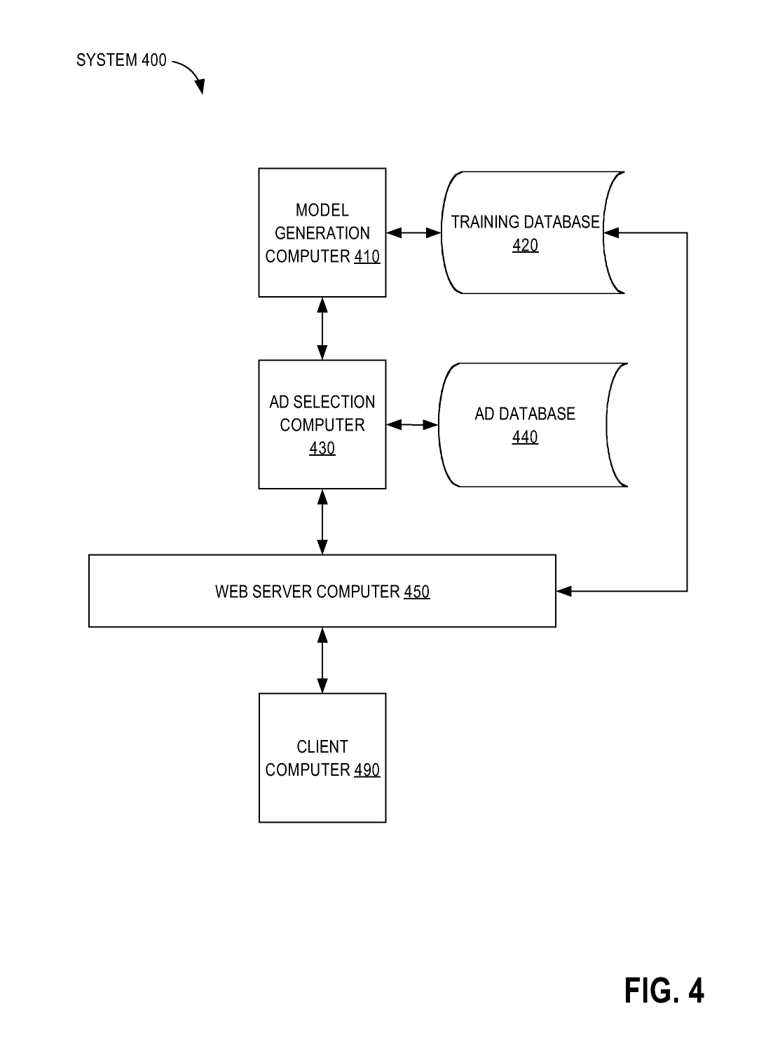

FIG. 4 illustrates a system upon which an embodiment of the invention may be implemented, in an example embodiment. System 400 includes model generation computer 410, training database 420, ad selection computer 430, ad database 440, web server computer 450, and client computer 490, which are communicatively coupled through one or more computer networks, such as a local area network, a wide area network, and/or the Internet. For purposes of illustrating a clear example, each computer and database is illustrated on a single, separate computer and/or device; however, each computer and/or database may comprise one or more computers and/or devices. For example, web server computer 450 may comprise a plurality of computers. Also for example, model generation computer 410 and ad selection computer 430 may be the same computer. Furthermore, while hundreds, thousands, or millions of client computers may be communicatively coupled to a server computer, such as web server computer 150, for purposes of illustrating a clear example a single client computer, client computer 490, is illustrated in system 400.

Model generation computer 410 performs one or more machine learning algorithms as discussed herein, using data in training database 420, to compute and/or generate one or more models. For example, training database 420 may perform logistic regression on data in training database 420 to compute a weight for each factor of a plurality of factors associated with, among other things, an ad, a web server, a web site, a client computer, a user using the client computer, and/or any other factors discussed herein. In an embodiment, model generation computer 410 comprises two or more computers running one or more algorithms, such as MapReduce and/or AllReduce, to compute and/or generate one or more models in a distributed computing system.

Training database 420 comprises historical information about previous ad presentations, the factors (both static, dynamic, and cached) associated with those ad presentations, and the latencies experienced during those ad presentations. The data in training database 420 may be received from web server computer 450. For example, in response to receiving a request for a web page with an ad slot from client computer 490, web server computer 450 may serve the requested web page and an ad to be included in the ad slot. Web server computer 450 may keep track of the latency of the served ad. Web server computer 450 may store any static and/or dynamic factors associated with the served ad and the latency in training database 420.

Ad selection computer 430 is communicatively coupled to model generation computer 410, ad database 440, and web server computer 450. Ad database 440 comprises ads and/or static factors associated with the ads. Ad selection computer 430 may receive a request from web server computer 450 for an ad to place in a particular ad slot in a web page. The request may include dynamic factors related to the user requesting the web page. In response to a request for an ad in a particular ad slot, ad selection computer 430 may select an ad from a plurality of ads in, referenced by, and/or described in, ad database 440 using the one or more models from model generation computer 410, static factors stored in ad database 440, and dynamic factors received in the request.

Web server computer 450 receives an ad, and/or a reference to an ad, selected by ad selection computer 430. Web server computer 450 includes the ad, and/or a reference to the ad, in a web page. Web server computer 450 may send the web page to client computer 490.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 500 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
a web server computer configured to:
receive, from a client computer, a request to provide, over a network, a piece of electronic content; and
determine the piece of electronic content includes an advertisement slot;
a latency prediction module configured to determine a predicted latency for each advertisement in a plurality of advertisements;
an ad selection computer configured to determine a particular advertisement of the plurality of advertisements to include in the advertisement slot based, at least in part, on the predicted latency for each advertisement in the plurality of advertisements.

2. The system of claim 1, wherein the latency prediction module is further configured to:
receive at least some data from the request;
determine at least one dynamic factor based, at least in part, on the request;
determine the predicted latency for each advertisement in the plurality of advertisements and based, at least in part, on the at least one dynamic factor.

3. The system of claim 1, wherein the latency prediction module is further configured to determine the predicted latency for each advertisement in the plurality of advertisements before the web server computer receives the request and based, at least in part, on one or more static factors.

4. The system of claim 1, wherein the ad selection computer is further configured to, for each advertisement in the plurality of advertisements, determine the predicted latency as a binary indicator, which indicates whether the advertisement is estimated be presented in an acceptably small amount of time.

5. The system of claim 1 comprising:
a training database;
a model generation computer coupled to the training database and configured to generate a model based on one or more factors and a latency associated with each ad presentation of a plurality of ad presentations;
wherein the latency prediction module configured to determine a predicted latency for each advertisement in the plurality of advertisements based, at least in part on the model.

6. The system of claim 5, wherein the latency prediction module is further configured to, for each ad presentation of the plurality of ad presentations, determine the latency based, at least in part, on a time between an ad request and rendering the ad presentation.

7. The system of claim 6, wherein the web server computer is coupled to the training database and further configured to, for each ad presentation of the plurality of ad presentations:
determine the one or more factors associated with the ad presentation;
determine the latency for the ad presentation; and
store the one or more factors and the latency for the ad presentation in the training database.

8. The system of claim 5, wherein the model generation computer is further configured to generate the model as a decision tree based on a machine learning algorithm.

9. The system of claim 5, wherein:
the model generation computer is further configured to generate the model comprising of a vector of weights based on a logistic regression of the one or more factors and the latency associated with ad presentation of the plurality of ad presentations;
the latency prediction module is further configured to determine the predicted latency for each advertisement in the plurality of advertisements based, at least in part on the vector of weights.

10. A method comprising:
receiving, at a server computer from a client computer, a request to provide, over a network, a piece of electronic content;
determining the piece of electronic content includes an advertisement slot;
determining a predicted latency for each advertisement in a plurality of advertisements;
determining a particular advertisement of the plurality of advertisements to include in the advertisement slot based, at least in part, on the predicted latency for each advertisement in the plurality of advertisements;
wherein the method is performed by one or more computing devices.

11. The method of claim 10 comprising:
determining at least one dynamic factor based, at least in part, on the request;
determining the predicted latency for each advertisement in the plurality of advertisements in response to receiving the request and based, at least in part, on the at least one dynamic factor.

12. The method of claim 10 comprising determining the predicted latency for each advertisement in the plurality of advertisements before receiving the request and based, at least in part, on one or more static factors.

13. The method of claim 10 comprising, for each advertisement in the plurality of advertisements, determining the predicted latency as a binary indicator, which indicates whether the advertisement is estimated to be presented in an acceptably small amount of time.

14. The method of claim 10 comprising:
generating a model based on one or more factors and a latency associated with each ad presentation of a plurality of ad presentations;
determining the predicted latency for each advertisement in the plurality of advertisements based, at least in part on the model.

15. The method of claim 14 comprising, for each ad presentation of the plurality of ad presentations, determining the latency based, at least in part, on a time between an ad request and rendering the ad presentation.

16. The method of claim 15 comprising, for each ad presentation of the plurality of ad presentations:
determining the one or more factors associated with the ad presentation;
determining the latency for the ad presentation; and
storing the one or more factors and the latency for the ad presentation.

17. The method of claim 14 comprising generating the model as a decision tree based on a machine learning algorithm.

18. The method of claim 14 comprising:
generating the model comprising of a vector of weights based on a logistic regression of the one or more factors and the latency associated with ad presentation of the plurality of ad presentations;
determining the predicted latency for each advertisement in the plurality of advertisements based, at least in part on the vector of weights.

19. A computer system comprising:
means for receiving, at a server computer from a client computer, a request to provide, over a network, a piece of electronic content;
means for determining the piece of electronic content includes an advertisement slot;
means for determining a predicted latency for each advertisement in a plurality of advertisements;
means for determining a particular advertisement of the plurality of advertisements to include in the advertisement slot based, at least in part, on the predicted latency for each advertisement in the plurality of advertisements.

20. The computer system of claim 19 comprising:
means for determining at least one dynamic factor based, at least in part, on the request;
means for determining the predicted latency for each advertisement in the plurality of advertisements in response to receiving the request and based, at least in part, on the at least one dynamic factor.
